(19) United States
(12) Patent Application Publication
(10) Pub. No.: US 2007/0178398 A1
(43) Pub. Date: Aug. 2, 2007

(54) TONER FOR ELECTROPHOTOGRAPHY, IMAGE FORMING APPARATUS, AND TONER MANUFACTURING METHOD

(76) Inventors: Yasuhiko Ogino, Kanagawa (JP); Takeo Yamaguchi, Kanagawa (JP); Masami Kadonaga, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/622,280

(22) Filed: Jan. 11, 2007

(30) Foreign Application Priority Data
Jan. 16, 2006 (JP) 2006-007045
May 26, 2006 (JP) 2006-147186

(51) Int. Cl. G03G 9/08

(52) U.S. Cl. 430/108.6; 430/111.4; 430/125.3; 430/110.3; 430/110.4; 430/137.1

(57) ABSTRACT

A toner for electrophotography satisfies Ft/Dt≦3.0 [nN/μm], where Ft is an inter-toner non-electrostatic adhesion force after a compressive stress within 0.7×10⁻² [N/m²] to 1.5×x10⁻² [N/m²] is applied, and Dt is a toner particle diameter. The inter-toner non-electrostatic adhesion force is obtained by filling a two-dividable cell for an Agrobot manufactured by Hosokawa Micron Corporation having a diameter of 15 mm, measuring a tension rupture stress required for dividing the cell after a compressive stress is applied, and substituting the tension rupture stress into Rumpf's equation.

### CROSS-REFERENCE TO RELATED APPLICATIONS

The present document incorporate by reference the entire contents of Japanese priority documents, 2006-007045 filed in Japan on Jan. 16, 2006 and 2006-147186 filed in Japan on May 26, 2006.

### BACKGROUND OF THE INVENTION

1. Field of the Invention

The present invention relates to a toner for electrophotography used in an image formation in which a toner image is formed by supplying a toner to a latent image formed on an image carrier, and the toner image is transferred onto a recording medium by using a transfer unit including an intermediate transfer member that on which the toner image is transferred from the image carrier, an image forming apparatus using the toner, and a method of manufacturing the toner.

2. Description of the Related Art

Conventionally, in this type of image formation, when the toner image on the image carrier is transferred onto the intermediate transfer member, a so-called center defect phenomenon may occur, in which part of the image is not transferred. This center defect phenomenon is particularly noticeable when a character image or line-shaped image is formed. A reason for this phenomenon is thought to be as follows. The toner image carried on the surface of the image carrier is carried in a state of protruding outside from the surface of the image carrier, and therefore the pressure at the time of transfer tends to concentrate on the toner. In particular, since a character image, a line-shaped image, or the like has a low area ratio, the mechanical pressure at the time of transfer onto the intermediate transfer member tends to concentrate on the toner. As a result, a center defect tends to occur.

To suppress such a center defect phenomenon, various measures have been conventionally taken. For example, in an image forming apparatus disclosed in Japanese Patent Application Laid-Open No. 20Q5-10389, when a character mode with a low image area ratio is selected, the pressure at the time of transfer is decreased to suppress a center defect. On the other hand, when an image mode with a high image area ratio is selected, the pressure at the time of transfer is increased to prioritize transferability.

As for an image forming apparatus disclosed in Japanese Patent Application Laid-Open No. 2004-334004, a method of improving a center defect by defining a toner agglomeration ratio when a specific load is put on the toner and also defining the load on the transfer unit is disclosed.

In an image forming apparatus disclosed in Japanese Patent Application Laid-Open No. 2001-235946, the surface roughness of the intermediate transfer member is larger than the surface roughness of the image carrier, and a relation between the average volume particle diameter of the toner for use and the values of the surface roughness of the intermediate transfer member and the image carrier are kept within a predetermined range. With this, the movement of the toner toward the intermediate transfer member side can be facilitated, whilst the movement of the toner toward the image carrier side can be suppressed, thereby suppressing the occurrence of a center defect phenomenon.

As for an image forming apparatus disclosed in Japanese Patent Application Laid-Open No. H6-250414, a method of suppressing a center defect by decreasing the surface energy of the image carrier to increase releasability of the toner attached by pressure onto the image carrier at the time of transfer is disclosed.

From diligent studies by the inventors, it has been revealed that such a center defect phenomenon at the time of transfer from the image carrier to the intermediate transfer member is significantly influenced by an inter-toner non-electrostatic adhesion force after a compressive stress is applied to the toner. That is, the inter-toner non-electrostatic adhesion force with respect to the toner particle diameter after compression is increased according to the magnitude of the compressive stress. When the same compressive stress is applied, a toner with a larger ratio of the inter-toner non-electrostatic adhesion force with respect to the toner particle diameter has a more exacerbated center defect phenomenon at the time of transfer. However, conventionally, the inter-toner non-electrostatic adhesion force of an electrophotographic toner for use in image formation after the compressive stress of the elecrophotographic toner is applied has not been taken into consideration.

### SUMMARY OF THE INVENTION

It is an object of the present invention to at least partially solve the problems in the conventional technology.

A toner for electrophotography according to one aspect of the present invention is used in an image formation in which a toner image is formed by supplying a toner to a latent image formed on an image carrier, and the toner image is transferred onto a recording medium by using a transfer unit including an intermediate transfer member that on which the toner image is transferred from the image carrier. The toner for electrophotography satisfies
Ft/Dt≦3.0 [nN/μm]
where Ft is an inter-toner non-electrostatic adhesion force after a compressive stress within 0.7×10⁻² [N/m²] to 1.5×10⁻² [N/m²] is applied, and Dt is a toner particle diameter. The inter-toner non-electrostatic adhesion force is obtained by filling a two-dividable cell for an Agrobot manufactured by Hosokawa Micron Corporation having a diameter of 15 millimeters, measuring a tension rupture stress required for dividing the cell after a compressive stress is applied, and substituting the tension rupture stress into Rumpf's equation, Ft=St×Dt²×ε/(1−ε), where St [nN/μm] is the tension rupture stress measured by applying a predetermined compressive stress to the toner, and ε is a toner-layer gap ratio.

An image forming apparatus according to another aspect of the present invention includes an image carrier on which a latent image is formed; a developing unit that forms a toner image by supplying a toner to the latent image formed on the image carrier; and a transfer unit including an intermediate transfer member unit on which of the toner image is transferred from the image carrier. The toner is a toner for electrophotography satisfying
Ft/Dt≦3.0 [nN/μm]
where Ft is an inter-toner non-electrostatic adhesion force after a compressive stress within 0.7×10⁻² [N/m²] to 1.5×10⁻² [N/m²] is applied, and Dt is a toner particle diameter. The inter-toner non-electrostatic adhesion force is obtained by filling a two-dividable cell for an Agrobot manufactured by Hosokawa Micron Corporation having a diameter of 15 millimeters, measuring a tension rupture stress required for dividing the cell after a compressive stress is applied, and substituting the tension rupture stress into Rumpf's equation, Ft=St×Dt²×ε/(1−ε), where St [nN/μm] is the tension rupture stress measured by applying a predetermined compressive stress to the toner, and ε is a toner-layer gap ratio.

A method according to still another aspect of the present invention is for manufacturing a toner for electrophotography that is used in an image formation in which a toner image is formed by supplying a toner to a latent image formed on an image carrier, and the toner image is transferred onto a recording medium by using a transfer unit including an intermediate transfer member that on which the toner image is transferred from the image carrier. The toner for electrophotography satisfies
Ft/Dt≦3.0 [nN/μm]
where Ft is an inter-toner non-electrostatic adhesion force after a compressive stress within 0.7×10⁻² [N/m²] to 1.5×10⁻² [N/m²] is applied, and Dt is a toner particle diameter. The inter-toner non-electrostatic adhesion force is obtained by filling a two-dividable cell for an Agrobot manufactured by Hosokawa Micron Corporation having a diameter of 15 millimeters, measuring a tension rupture stress required for dividing the cell after a compressive stress is applied, and substituting the tension rupture stress into Rumpf's equation, Ft=St×Dt²×ε/(1−ε) where St [nN/μm] is the tension rupture stress measured by applying a predetermined compressive stress to the toner, and ε is a toner-layer gap ratio. The toner for electrophotography includes a first toner manufactured so that an average value of the circularity is larger than a predetermined value, and a second toner manufactured so that an average value of the circularity is smaller than the predetermined value. The toner for electrophotography is manufactured by mixing the first toner and the second toner in a container at a time of shipping.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic drawing of the structure of a printer according to a first example;

FIG. 2 is a graph depicting a relation between a spring force of a secondary transferring unit and a degree of center defect in a plurality of toner samples; and

FIG. 3 is a graph depicting an applied compressive stress [N/m²] and Ft/Dt [nN/μm] in a plurality of toner samples.

### DETAILED DESCRIPTION OF THE PREFERRED EMBODIMENTS

Exemplary embodiments of the present invention are explained in detail below with reference to the accompanying drawings.

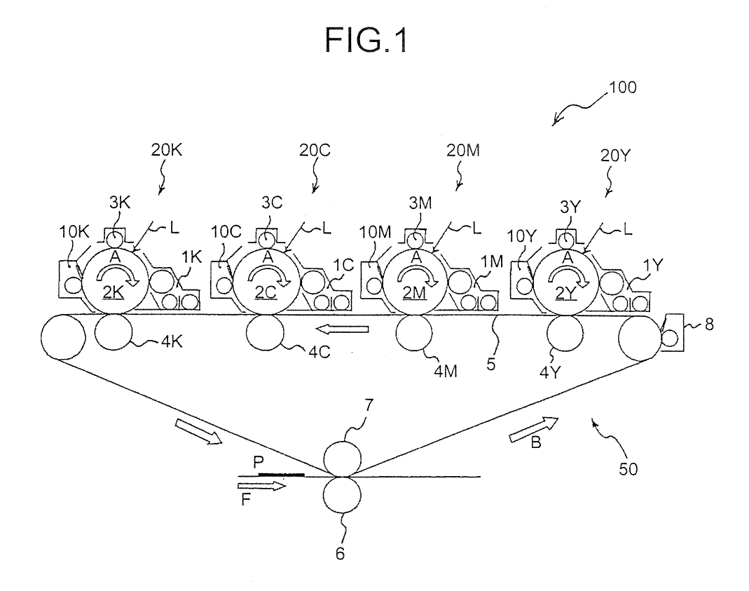

FIG. 1 is a schematic drawing of the entire structure of a printer 100 serving as a full-color image forming apparatus. In FIG. 1, the printer 100 includes four sets of image forming units 20Y, 20M, 20C, and 20K using toners of different four colors (yellow: Y, magenta: M, cyan: C, and black: K). Furthermore, an intermediate transfer unit 50 is provided as a transfer unit including an intermediate transfer belt 5 serving as an intermediate transfer member onto which toner images formed in the image forming units 20Y, 20M, 20C, and 20K are transferred. The printer 100 is a tandem-type image forming apparatus in which four sets of image forming units 20Y, 20M, 20C, and 20K are arranged in parallel along a direction in which the intermediate transfer belt 5 moves.

The image forming units 20Y, 20M, 20C, and 20K include photosensitive drums 2Y, 2M, 2C, and 2K as the image carrier and charging devices 3Y, 3M, 3C, and 3K that each charge the surface of the relevant photosensitive drum by a charging roller, respectively. Also, exposing devices not shown are provided that each expose the charged surface of the relevant one of the photosensitive drums 2Y, 2M, 2C, and 2K to leaser light L based on an image information to form a latent image on the surface. Furthermore, developing devices 1Y, 1M, 1C, and 1K serving as image forming units that each change the latent image on the relevant one of the photosensitive drums 2Y, 2M, 2C, and 2K to a toner image, and photosensitive cleaning devices 10Y, 10M, 10C, and 10K that each clean the surface of the relevant one of the photosensitive drums 2Y, 2M, 2C, and 2K are provided.

The photosensitive drums 2Y, 2M, 2C, and 2K of the four sets of image forming units are driven by a photosensitive-drum driving device not shown for rotation in a direction represented by an arrow A in the drawing. Also, the black photosensitive drum 2K and the color photosensitive drums 2Y, 2M, and 2C may be independently driven for rotation. With this, when a monochrome image is formed, for example, only the black photosensitive drum 2K can be driven for rotation, and when a color image is formed, four photosensitive drums 2Y, 2M, 2C, and 2K can be simultaneously driven for rotation. Here, when a monochrome image is formed, the intermediate transfer unit having the intermediate transfer belt 5 is partly rocked so as to be away from the color photosensitive drums 2Y, 2M, and 2C.

The intermediate transfer belt 5 is formed of an endless belt material with an intermediate resistance, for example, and is wound over a secondary transferring unit's facing roller 7, a plurality of supporting rollers, and others. With one of these rollers being driven for rotation, the intermediate transfer belt 5 can be endlessly moved in the direction represented by the arrow in the drawing.

At primary transfer positions where toner images are transferred from the photosensitive drums 2Y, 2M, 2C, and 2K to the intermediate transfer belt 5, primary transfer rollers 4Y, 4M, 4C, and 4K are provided so as to face the photosensitive drums 2Y, 2M, 2C, and 2K across the intermediate transfer belt 5. The intermediate transfer belt 5 serving as a transfer member is pressed by the primary transfer rollers 4Y, 4M, 4C, and 4M to be attached by pressure onto the photosensitive drums 2Y, 2M, 2C, and 2K, thereby each forming a primary transfer nip with a facing portion of the relevant one of the photosensitive drums 2Y, 2M, 2C, and 2K.

Also, at positions where the secondary transferring unit's facing roller 7 faces via the intermediate transfer belt 5, a secondary transfer roller 6 is provided that abuts on the intermediate transfer belt 5 with a predetermined nip pressure and transfers the toner images formed on the intermediate transfer belt 5 onto a transfer sheet P, which a recording member.

In the printer 100 configured as above, when a color image is formed, the photosensitive drums 2Y, 2M, 2C, and 2K are driven for rotation in the direction represented by the arrow A in the drawing. At this time, the surfaces of the photosensitive drums 2Y, 2M, 2C, and 2K are charged by the charging devices 3Y, 3M, 3C, and 3K to a predetermined polarity, for example, a minus polarity. Next, the charged surfaces of the photosensitive drums 2Y, 2M, 2C, and 2K are radiated with optically-modulated laser light L emitted from an image writing unit. With this, electrostatic latent images are formed on the photosensitive drums 2Y, 2M, 2C, and 2K. That is, portions radiated with laser light and having a decreased absolute value of a potential on the surface portions of the photosensitive members are electrostatic latent image (image portions), whilst portions not radiated with laser light and keeping a high absolute value of a potential are background portions. Next, the electrostatic latent images are developed with toner accommodated in the developing devices 1Y, 1M, 1C, and 1K and charged with a predetermined polarity, thereby causing these images to be visualized as toner images.

The toner images of respective colors formed on the photosensitive drums 2Y, 2M, 2C, and 2K are transferred onto the intermediate transfer belt 5 at the respective primary transfer nips by action of pressure and a transfer electric field so as to be sequentially superposed one another. With this, a full-color toner image formed of four-color toner images are formed on the intermediate transfer belt 5.

The transfer residual toner not transferred onto the intermediate transfer belt 5 and remaining on the photosensitive drums 2Y, 2M, 2C, and 2K is scraped by the photosensitive member cleaning devices 10Y, 10M, 10C, and 10K, thereby cleaning the surface of the photosensitive drums 2Y, 2M, 2C, and 2K. Here, the toner removed from the photosensitive drums 2Y, 2M, 2C, and 2K can be conveyed to the developing devices by toner recycling devices not shown for recycling the toner.

On the other hand, the transfer sheet P is conveyed from a paper feeding device not shown to a position between the intermediate transfer belt 5 and the secondary transfer roller 6 from a direction represented by an arrow F at a predetermined timing. At this time, the full-color toner image formed through superposition on the intermediate transfer belt 5 is collectively transferred onto the transfer sheet P by a secondary transfer nip formed between the secondary transfer roller 6 and the secondary transferring unit's facing roller 7. The transfer sheet P having the full-color toner image transferred thereon is heated and pressured by a fixing device not shown, thereby causing the toner image to be fixed onto the transfer sheet P. Then, the recording sheet having the toner image fixed thereto by the fixing device not shown is delivered from a delivering unit not shown.

The configuration of the printer 100 is not restricted to that explained with reference to FIG. 1. In general, in the primary transfer process of the image forming apparatus, for the purpose of improving a transfer ratio and suppressing unevenness in transfer, the transferring unit is contacted by pressure. However, due to the properties of the toner and the pressure of the nip portion, a “center defect” phenomenon occurs, in which part of a character image or line-shaped image is lost or re-transferred onto the image carrier. In the present embodiment, in consideration of such a “center defect” phenomenon and an inter-toner non-electrostatic adhesion force after compression, a toner whose inter-toner non-electrostatic adhesion force after compression has an appropriate magnitude is used, thereby making it possible to significantly reduce a center defect phenomenon.

The toner for use in the present embodiment is explained below. First, a method of calculating an inter-toner non-electrostatic adhesion force after compression for use as a value representing a property of the toner is explained.

The inter-toner non-electrostatic adhesion force Ft (nanonewtons) can be calculated by
Ft=St×Dt²×ε/(1−ε) (Rumpf's equation)
where St [nN/μm²] is a toner's tension rupture stress, Dt (micrometers) is the toner particle diameter, and ε is the toner-layer gap ratio.

The toner's tension rupture stress St [nN/μm²] is measured by using Agrobot (from Hosokawa Micron Corporation), which is a powder layer compression and tension strength automatic measuring system, to apply a predetermined compressive stress. Details of measurement conditions are explained further below. This apparatus encapsulates a powder sample in a two-dividable cell, and after pressuring the cell by a set pressure, calculates a force used for rupture and an inter-toner adhesion force from a force required for diving into upper and lower cells.

The toner particle diameter Dt (micrometers) can be measured by Coulter Multisizer from Coulter Electric.

The toner-layer gap ratio ε can be calculated from the height of a toner layer measured by Agrobot and an absolute specific gravity of toner powder. The height of the toner layer is that after a compressive stress is applied by Agrobot, and the absolute specific gravity is measured by using an absolute specific gravity measuring apparatus (a dry automatic densimeter of Accupyc 1330 from Shimadzu Corporation).

The inter-toner non-electrostatic adhesion force is considered to be based on the Van der Waals force. An example of a scheme of measuring the adhesion force of the toner is a centrifugal separation scheme. According to The Society for Imaging Science and Technology (IS&T) Non-Impact Printing (NIP) 7th International Conference on Digital Printing Technologies, p. 200 (1991), the toner non-electrostatic adhesion force Ft (nanonewtons) is proportional to the toner particle diameter Dt (micrometers). Therefore, through comparison in Ft/Dt [nN/μm], comparison in magnitude of the toner non-electrostatic adhesion force can be performed independently from the toner particle diameter.

In the Rumpf's equation, the tension rupture stress St [nN/μm²] is multiplied by the square of the toner particle diameter Dt (micrometers). This multiplication is performed in order to calculate the number of particles present in an area of a ruptured section, and is not associated with the properties of the inter-toner non-electrostatic adhesion force Ft (nanonewtons).

In Ft/Dt [nN/μm], Ft (nanonewtons) is divided by Dt (micrometers) in consideration of the property in which the inter-toner non-electrostatic adhesion force Ft (nanonewtons) is proportional to the particle diameter Dt (micrometers). The property in which the inter-toner non-electrostatic adhesion force Ft (nanonewtons) is proportional to the particle diameter Dt (micrometers) can be explained from experimental results obtained by measuring the adhesion force between the toner and the plane through centrifugal separation scheme or from a general Van der Waals force equation. Even in a force between particles in the toner layer measured by using Agrobot, it can be thought that the inter-toner non-electrostatic adhesion force Ft (nanonewtons) is proportional to the particle diameter Dt (micrometers).

If the toner particle diameter Dt (micrometers) is increased even with the same magnitude of the inter-toner non-electrostatic adhesion force Ft (nanonewtons), a center defect tends not to occur. A main reason for this is thought to be such that, if the toner particle diameter Dt (micrometers) is increased even with the same magnitude of the inter-toner non-electrostatic adhesion force Ft (nanonewtons), the adhesion force between the toner particles and the photosensitive member and the adhesion force between the toner particles and the transfer belt are increased compared with the case of a smaller toner particle diameter Dt (micrometers), and therefore the possibility that the toner cannot exist as an aggregate is increased. Other than that, when the surface charge density of the toner is the same, the charge of one toner is proportional to the square of the toner particle diameter Dt (micrometers). Therefore, for example, when the toner particle diameter Dt (micrometers) becomes ½, the amount of charge q becomes ¼. In this case, since the toner particle is moved by a force qE from an external electric field, the force qE from the external electric field becomes ¼, but the non-electrostatic adhesion force between the toner and the photosensitive member becomes merely ½. Therefore, even when the force between the toner particles and the photosensitive member is decreased, the toner becomes relatively difficult to be moved. Also, in consideration of influences, such as gravity, the force becomes ⅛ because it is proportional to the mass. As such, when the toner particle diameter is decreased, the non-electrostatic adhesion force between toner particles is decreased, but the external force to move is further decreased. Therefore, as the toner particle diameter Dt (micrometers) is decreased (even with a decreased value of the adhesion force), the adhesiveness and agglomeration properties are increased. In consideration of these influences, Ft (nanonewtons) is divided by Dt (micrometers). Thus, the toner's adhesion force and the agglomeration force cannot be compared only based on the magnitude of Ft (nanonewtons).

The inventors used Agrobot to measure inter-toner non-electrostatic adhesion forces of various compressed toners with different properties for quantitative evaluation and studied the relation as to a center defect phenomenon occurring in the image forming apparatus.

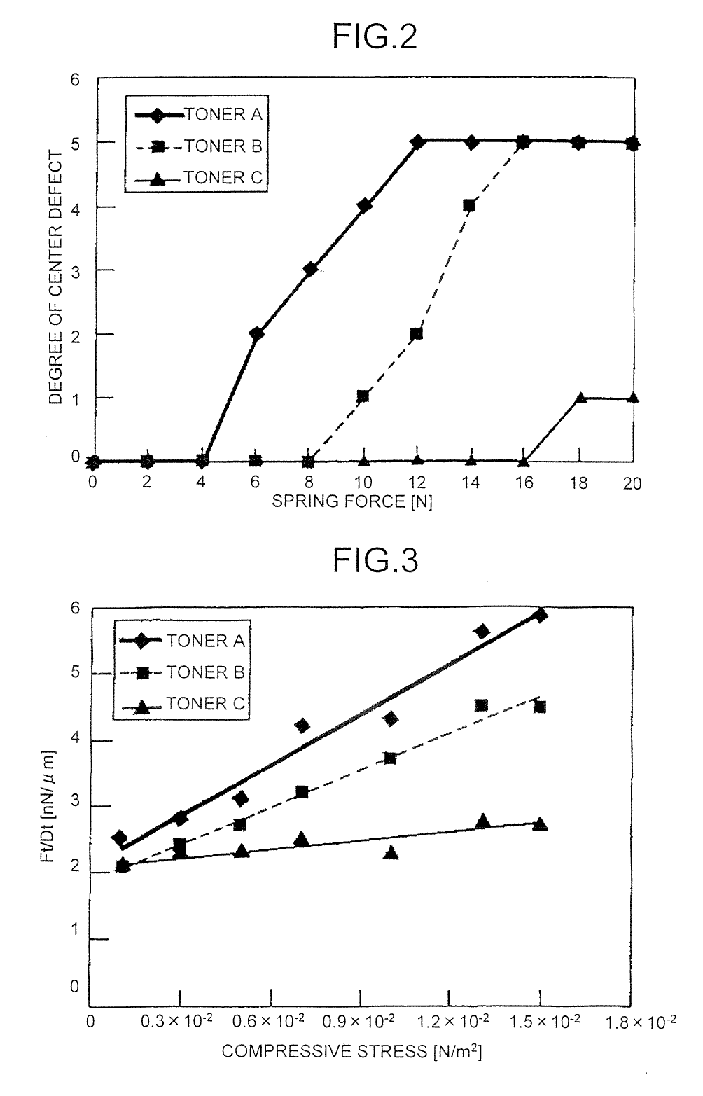

FIG. 2 is a graph depicting a relation between a transfer pressure spring force and a degree of center defect measured by using the existing image forming apparatus for three arbitrary types of toner samples A, B, and C with different properties. The image forming apparatus was a tandem full-color printer of an intermediate transfer type, used a single color mode, and outputted an image based on each toner with a transfer pressure being varied.

In FIG. 2, a transfer pressure spring force indicates the magnitude of a spring force for pressing the intermediate transfer member and the photosensitive member to assist transfer. In the apparatus, one pressure spring is placed at each of both ends of the transfer roller, and the transfer pressure spring force is a total value of spring forces at both ends. The degree of center defect represents an evaluation ranking from 1 to 5 for the state of center defect on an output image by using a test chart with thin lines of 3 dots in a main operating direction by 60 dots in a sub-operating direction being equally arranged. This test chart assumes a character image, line-shaped image, or the like, that has a small image area ratio, and represents a condition in which the pressure tends to concentrate on the toner image.

Evaluation standards of the respective ranks are as follows.

First rank: a state in which a “center defect” portion is not found through visual observation

Second rank: a state in which a “center defect” portion can be barely found through visual observation to such an extent that it is difficult to determine a certain portion as a “center defect” portion

Third rank: a state in which a “center defect” portion can be barely found through visual observation and the “center defect” portion does not impair image quality

Fourth rank: a state in which a “center defect” portion can be found relatively easily through visual observation

Fifth rank: a state in which a “center defect” portion can be immediately found by anyone through visual observation

The second rank and lower are within a range in which there is no problem as an image. Also, the spring force equal to or larger than 16 newtons exceeds a spring force for normal use. As such, in evaluation by the image forming apparatus, the relation between the spring force and the degree of center defect is varied depending on the toner. In FIG. 2, a toner sample C has a high degree of margin for center defect, and is therefore preferable.

As for the photosensitive member and the intermediate transfer belt of the full-color printer for use in measurement depicted in FIG. 2, any of those satisfying the following conditions (1) to (3), which are within a range of normal use, have similar tendencies when an experiment is carried out within a spring force shown in FIG. 2.

(1) Surface roughness between the photosensitive member and the intermediate transfer belt

Rz (ten point height of irregularities): 0.1 micrometers to 3 micrometers

Measurement device: Laser microscope (VK-8500 from Keyence Corporation)

(2) Surface energies of the photosensitive member and the transfer belt

Water contact angle: 50° C. to 120° C.

<Water Contact Angle>

Measurement device and measurement conditions

Measurement device: FACE automatic contact angle meter of CA-W type from Kyowa Interface Science Co., Ltd.

Measurement intervals: 10 millimeters

The number of repeating times: five times

(3) Coefficient of friction between the photosensitive member and the transfer belt

Coefficient of friction: 0.1 to 0.7

Measurement scheme: Euler belt scheme

A measurement sheet (PPC paper TYPE 6200 from Ricoh Company Ltd., A4 size, long-fold) is cut into a size of 297 millimeters×30 millimeters, and the center portion of this measurement sheet is wound in a circumferential direction of the photosensitive drum within a 90 degrees (π/2 rad.). Then, a load (100 grams) is applied to one end (lower end) of the measurement sheet and a force gauge is connected to the other end. The force gauge is moved at a constant speed. After the measurement sheet is started to move, a stabilized value of the force gauge value is read, and calculation is performed by using the following equation.
μk=2π×In(F/W)
where μk is a coefficient of kinetic friction, F is a read force gauge value [gram], and W is a load [100 grams].

The coefficient of friction of the transfer belt is measured in a manner similar to that for measuring the coefficient of friction of the photosensitive drum, with the transfer belt desired to be measured being wound around the photosensitive drum or a base having a diameter equal to the diameter of the photosensitive drum, and with the photosensitive drum or the base having a diameter equal to the diameter of the photosensitive drum, and the transfer belt being fixed so as not to slide.

By using Agrobot explained above, the toner's tension rupture stress (St [nN/μm²]) after a plurality of compressive stresses were applied was measured for each of the toner samples A, B, and C depicted in FIG. 2. At this time, the toner powder was encapsulated in a two-dividable cell for Agrobot having a diameter of 15 millimeters up to 90% of the height. After a compressive stress was applied to a toner layer in the cell, the cell was pulled in a vertical direction to measure the toner's tension rupture stress. When the toner particles were encapsulated in the cell, approximately half of the toner was put in the cell and was then lightly tapped ten times, and the remaining half was put therein and was then lightly tapped ten times. 90% of the height of the cell was measured by sight. Also, the height of the toner layer after the compressive stress was applied was measured, and the gap ratio ε of the toner layer was calculated from the absolute specific gravity value of the toner previously measured. These toner's tension rupture stress St [nN/μm²] and gap ratio ε of the toner layer and the toner particle diameter Dt (micrometers) previously measured are substituted into the Rumpf's equation: Ft=St×Dt²×ε/(1−ε) to calculate the inter-toner non-electrostatic adhesion force Ft [nN].

A relation between Ft/Dt [nN/μm] obtained by dividing the inter-toner non-electrostatic adhesion force Ft after the calculated compressive stress is applied by the toner particle diameter Dt and the applied compressive stress is depicted in FIG. 3. As for the sample toner C, in which a center defect tends not to occur with a high spring force as depicted in FIG. 2, even when a high compressive stress is applied, the value of Ft/Dt obtained by dividing the inter-toner non-electrostatic adhesion force Ft by the toner particle diameter Dt is not increased, as depicted in FIG. 3. Specifically, the value of Ft/Dt [nN/μm] was equal to or smaller than 3.0 [nN/μm] after the compressive stress within a range of 0.7×10⁻² [N/m²] to 1.5×10⁻² [N/m²] is applied.

As a result of many studies on the relation of the value of Ft/Dt [nN/μm] of the toner and the compressive stress to be applied and the relation between the transfer spring force and center defect in the image forming apparatus, the inventors have found that “center defect” can be suppressed through the following method. That is, to obtain the toner for electrophotography, toner powder is encapsulated in a two-dividable cell for Agrobot having a diameter of 15 millimeters, and a compressive stress within 0.7×10⁻² [N/m²] to 1.5×10⁻² [N/m²] is then applied. Ft/Dt [nN/μm] of the obtained toner calculated from a toner's tension rupture stress after the compressive stress by using the Rumpf's equation satisfies Equation (1), where Ft is an inter-toner non-electrostatic adhesion force (nanonewtons) after compression and Dt is a toner particle diameter (micrometers). By using this toner, a “center defect” phenomenon in the image forming apparatus can be suppressed.
Ft/Dt≦3.0 [nN/μm] (1)

When a toner whose Ft/Dt [nN/μm] exceeds 3.0 [nN/μm] after the compressive stress of 0.7×10⁻² [N/m²] to 1.5×10⁻² [N/m²] is applied is used, the toner tends to be agglomerated at the transfer nip portion, and a “center defect” phenomenon tends to occur at a fine line, for example.

The present inventors also have found a condition for the toner particles that an average value of circularities represented by Equation (2) is preferably 1.0 to 1.4, so as to satisfy the conditions explained above. The circularity becomes near 1 as the toner particle is near spherical.
Circularity={(circumferential length of the particle)2/(projection area of the particle)}×(¼π) (2)

The circularity is 1.0 if the toner particle is a complete sphere. As the value of the circularity is smaller, the toner particle has a shape more similar to a spherical shape. Also, it has been confirmed through experiments performed by the inventors or the like that, as the value of the circularity is smaller, that is, as the toner particle has a shape more similar to a spherical shape, an amount of increase in the toner's electrostatic adhesion force with respect to an amount of increase in compressive load to be applied by Agrobot is smaller. On the other hand, if the average value of circularities exceeds 1.4, the agglomeration property is increased. With this, the toner tends to become an aggregate at the time of pressure, and therefore a center defect often occurs. In one method of measuring the circularity, for example, FE-SEM (S-4500) from Hitachi, Ltd. is used to randomly sample hundred toner images enlarged by 1000 times, and then their image information are analyzed by using, for example, image processing software (Image-Pro Plus from Media Cybernetics) for calculation.

As has been explained above, in view of suppressing a center defect, it is preferable that the circularity of the toner be as close to 1.0 as possible. With a toner with a circularity close to 1.0, a center defect tends not to occur and a transfer ratio is high. Therefore, although the transfer residual toner is decreased, removal of such transfer residual toner is difficult. This is because, when the transfer residual toner is cleaned by a cleaning blade, if the toner has an approximately spherical shape, the toner passes through between the photosensitive member surface and the cleaning blade as being rotated. As a result of measurement by the inventors of several samples on the market, it has been revealed that the circularity is preferably equal to or larger than 1.25 in terms of cleaning.

In consideration of cleaning ability, it is preferable that the toner have a circularity larger than 1.0 as much as possible. However, the toner with its circularity close to 1.0 is a polymeric toner and such a polymeric toner is chemically manufactured, and therefore its shape is approximately spherical and it is technically difficult to control the circularity so that it is larger than 1.0.

To get around such a problem, a grinded toner with a circularity equal to or larger than 1.4 is mixed with a copolymer toner with its circularity equal to or smaller than 1.4, thereby suppressing a “center defect” phenomenon and improving cleaning ability. With a grinded toner with a circularity equal to or larger than 1.4 being mixed with a spherical toner with its circularity equal to or smaller than 1.4, an aggregate tends not to be formed even in the case of a grinded toner, thereby preventing a “center defect” phenomenon. Also, by mixing a grinded toner, which is an indefinitely-shaped toner, cleaning ability can be increased even with the use of a spherical toner. This is because, with indefinite substances entering as a collection, the indefinitely-shaped toner particles suppress the rotation of the spherical toner particles. Also, the indefinitely-shaped toner particles are stuck in a space between the cleaning blade and the photosensitive member, and therefore the spherical toner can be prevented from entering that gap.

In one method of using toners having different shapes, such as an indefinitely-shaped powder toner and a spherical polymeric toner, a toner container having toners mixed in advance at a predetermined ratio at the time of shipping is attached to the image forming apparatus for use. In this case, such an attaching operation is similar to a normal toner replacing operation, and therefore this operation does not impose a burden on the user. In another method, toners having different shapes can be mixed and stirred in a unit that mixes and stirs with a carrier. In this case, the toners having different shapes may be sealed in different containers at the time of toner supply and then be mixed at the time of mixing and stirring with a carrier. Alternatively, in a developer having a carrier and a toner being stirred in advance, a toner having a different shape may be mixed. As such, if any one of these methods of separately supplying toners having different shapes is taken, an average value of circularities of toners for use can be adjusted by changing the toner mixing ratio according to the situation.

Basically, any known materials can be utilized to make the toner for use in the image forming apparatus according to the present embodiment. Example of binder resins includes styrenes, such as polystyrene, poly-p-chlorostyrene and polyvinyltoluene, and copolymers of their substitution products. Examples of the substitution copolymers of styrene include styrene-based copolymers, such as a styrene-p-chlorostyrene copolymer, a styrene propylene copolymer, a styrene-vinyltoluene copolymer, a styrene-vinylnaphthalene copolymer, a styrene-methylacrylate copolymer, a styrene-ethylacrylate copolymer, a styrene-butylacrylate copolymer, a styrene-octylacrylate copolymer, a styrene-methylmethacrylate copolymer, a styrene-ethylmethacrylate copolymer, a styrene-butylmethacrylate copolymer, a styrene-methyl-.alpha.-chloromethacrylate copolymer, a styrene-acrylonitrile copolymer, a styrene-vinylmetyl ketone copolymer, a styrene-butadiene copolymer, a styrene-isoprene copolymer, a styrene-acrylonitrile-indene copolymer, a styrene-maleic acid copolymerm and a styrene maleic acid ester copolymer; polymethyl methacrylate, polybutyl methacrylate, polyvinyl chloride, polyvinyl acetate, polyethylene, polypropylene, polyester, epoxy resin, epoxy polyol resin, polyurethane, polyamide, polyvinyl butyral, polyacrylic resin, rosin, modified rosin, terpene resin, aliphatic resin or aliphatic hydrocarbon resin, aromatic petroleum resin, chlorinated paraffin, and a paraffin wax.

As a coloring agent, all known dyes and pigments can be used, including the following dyes and pigments, for example, and any mixtures thereof: carbon black, nigrosine dyes, black iron oxide, Naphthol Yellow S, Hansa Yellow (10G, 5G, G), cadmium yellow, yellow iron oxide, yellow ochre, chrome yellow, Titan Yellow, Polyazo Yellow, Oil Yellow, Hansa Yellow (GR, A, RN, R), Pigment Yellow L, Benzidine Yellow (G, GR), Permanent Yellow (NCG), Vulcan Fast Yellow (5G, R), Tartrazine Lake, Quinoline Yellow Lake, Anthrazan Yellow BGL, isoindolinone yellow, red oxide, red lead oxide, red lead, cadmium red, cadmium mercury red, antimony red, Permanent Red 4R, Para Red, Fire Red, parachlororthonitroaniline red, Lithol Fast Scarlet G, Brilliant Fast Scarlet, Brilliant Carmine BS, Permanent Red (F2R, F4R, FRL, FRLL, F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, eosine lake, Rhodamine Lake B, Rhodamine Lake Y, Alizarine Lake, Thioindigo Red B, Thioindigo Maroon, Oil Red, quinacridone red, Pyrazolone Red, Polyazo Red, Chrome Vermilion, Benzidine Orange, Perynone Orange, Oil Orange, cobalt blue, cerulean blue, Alkali Blue Lake, Peacock Blue Lake, Victoria Blue Lake, metal-free phthalocyanine blue, Phthalocyanine Blue, Fast Sky Blue, Indanthrene Blue (RS, BC), indigo, ultramarine, Prussian blue, Anthraquinone Blue, Fast Violet B, Methyl Violet Lake, cobalt violet, manganese violet, dioxazine violet, Anthraquinone Violet, chrome green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc white, and lithopone.

In general, the amount of use of the coloring agent is 0.1% by weight to 50% by weight with respect to 100% by weight of binder resin.

The toner manufacturing method according to the present embodiment is not particularly restricted, and any can be selected as appropriate according to the purpose. Since a toner whose area-average particle diameter is small can be suitably used in a toner image with high image quality, a toner manufactured through a polymerizing method explained below is preferable.

For example, the method includes a step of dispersing and reacting, in a water-based medium, an active-oxygen-containing compound, a polymer having a portion that can be reacted with the active-oxygen-containing compound, and at least two types of resin fine particles to produce an adhesive base material and obtain a toner, and further includes other steps selected as required.

In the step explained above, for example, preparing a water-based medium phase, preparing an organic solvent phase, emulsification and dispersion, and others (synthesizing the polymer (prepolymer) that can be reacted with the active-water-containing compound, synthesizing the active-water-containing compound, and others) are performed.

The water-based medium phase can be prepared by dispersing at least two types of resin fine particles in the water-based medium. The amount of addition of the resin fine particles to the water-based medium is not particularly restricted and can be selected as appropriate according to the purpose, and is preferably 0.5% by weight to 10% by weight.

The organic solvent can be prepared by dissolving or dispersing, in the organic solvent, toner materials, such as the active-water-containing compound, a polymer that can be reacted with the active-water-containing compound, the coloring agent, the releasing agent, the charge control agent, and the unmodified polyester resin.

Of these toner materials, components other than the polymer (prepolymer) that can be reacted with the active-water-containing compound may be added, in the water-based medium phase preparation, to the water-based medium for mixture when the resin fine particles are dispersed in the water-based medium. Alternatively, such components may be added to the water-based medium phase together with the organic solvent phase when the organic solvent phase is added to the water-based medium phase.

The organic solvent is not particularly restricted as long as it can cause the toner materials to be dissolved or dispersed and can be selected as appropriate according to the purpose. In view of easy removal, a volatile organic solvent having a boiling point lower than 150° C. is preferable. Examples of such organic solvent include toluene, xylene, benzene, carbon tetrachloride, methylene chloride, 1,2-dichloroethane, 1,1,2-trichloromethane, trichloroethylene, chloroform, monochlorobenzene, dichloroethylidene, methyl acetate, ethyl acetate, methyl ethyl ketone, methyl isobutyl ketone. Among these solvents, ethyl acetate, toluene, xylene, benzene, methylene chloride, 1,2-dichloroethane, chloroform, and carbon tetrachloride are particularly preferable, for example. Each of these solvents can be used either alone or in combination of two or more.

The amount of use of the organic solvent is not particularly restricted, and any can be selected as appropriate according to the purpose. For example, for 100% by weight of the toner material, the amount of use of the organic solvent is preferably 40 parts to 300 parts, more preferably, 60 parts to 140 parts, and still more preferably, 80 parts to 120 parts.

Emulsification and dispersion can be achieved by emulsifying and dispersing the organic solvent phase in the water-based medium phase. At the time of emulsification and dispersion, when the active-oxygen-containing compound and a copolymer that can be reacted with the active-oxygen-containing compound are subjected to elongation reaction or crosslinking reaction, the adhesive base material is produced.

The adhesive base material (for example, the urea-modified polyester resin) may be produced by (1) emulsifying and dispersing the organic solvent phase containing a copolymer that can be reacted with the active-oxygen-containing compound (for example, the isocyanate-containing polyester prepolymers (A)) together with the active-oxygen-containing compound (for example, the amines (B)) in the water-based medium phase to form a dispersoid and then subjecting both to elongation reaction or crosslinking reaction in the water-based medium phase; (2) emulsifying and dispersing the organic solvent phase in the water-based medium added in advance with the active-oxygen-containing compound to form a dispersoid and then subjecting both to elongation reaction or crosslinking reaction in the water-based medium phase; or (3) first adding and mixing the organic solvent phase in the water-based medium, then adding the active-oxygen-containing compound to form a dispersoid, and then subjecting both to elongation reaction or crosslinking reaction in the water-based medium phase from the particle surface. Here, in the case of (3), modified polyester resin is preferentially produced on the surface of the toner to be produced, and therefore a concentration gradient can be provided in the toner particles.

The reaction conditions for generating the adhesive base material through emulsification and dispersion is not particularly restricted, and any can be selected as appropriate according to a combination of the copolymer that can be reacted with the active-water-containing compound and the active-water-containing compound. The reaction time is preferably ten minutes to 40 hours, and more preferably, 2 hours to 24 hours. The reaction temperature is preferably 0° C. to 150° C., more preferably, 40° C. to 98° C.

Examples of a method of stably forming a dispersoid containing the copolymer that can be reacted with the active-water-containing compound (for example, the isocyanate-containing polyester prepolymer (A)) include a method of adding to the water-based medium phase the toner materials, such as the copolymer that can be reacted with the active-water-containing compound (for example, an isocyanate-containing polyester prepolymer (A)) dissolved or dispersed in the organic solvent, the coloring agent, the releasing agent, the charge control agent, and the unmodified polyester resin.

The dispersing method is not particularly restricted, and any can be selected as appropriate by using a known dispersing device or the like. Examples of the dispersing device include a low-speed shearing-type dispersing device, a high-speed shearing-type dispersing device, a friction-type dispersing device, a high-pressure jet-type dispersing device, and a ultrasonic dispersing device. Among these, a high-speed shearing-type dispersing device is preferable in view of the capability of controlling the particle diameter of the dispersoid at 2 micrometers to 20 micrometers.

When a high-speed shearing-type dispersing device is used, the number of rotations, a dispersing time, a dispersion temperature, or other conditions is not particularly restricted, and any can be selected as appropriate according to the purpose. For example, the number of rotations is preferably 1000 revolutions per minute (RPM) to 30,000 RPM, and more preferably, 5000 RPM to 20,000 RPM. The dispersion time is preferably 0.1 minutes to 5 minutes in a batch system. The dispersing temperature is preferably 0° C. to 150° C. under a pressure, and more preferably, 40° C. to 98° C. In general, dispersion is easy at a high temperature.

In emulsification and dispersion, the amount of use of the water-based medium is preferably 50 parts to 2,000 parts with respect to 100 parts of the toner material, and more preferably, 100 parts to 1,000 parts.

When the amount of use is smaller than 50 parts, the state of dispersion of the toner material is poor, and the toner particles having a predetermined particle diameter may not be obtained. When the amount of use exceeds 2,000 parts, producing cost may be increased.

In emulsification and dispersion, in view of sharpening the particle size distribution and performing stable distribution, a dispersing agent is preferably used as required.

The dispersing agent is not particularly restricted, and any can be selected as appropriate according to the purpose. Examples of the dispersing agent include surfactants, inorganic-compound dispersing agents that are slightly soluble in water, and polymeric protective colloids. These may be used either alone or in combination of two or more. Among these, surfactants are preferable.

Examples of the surfactants include anionic surfactants, cationic surfactants, and nonionic surfactants, and amphoteric surfactants.

Examples of the anionic surfactants include alkylbenzene sulfonates, alpha-olefinsulfonates, and phosphoric esters, and those containing a fluoroalkyl base are preferable.

Examples of such fluoroalkyl-containing anionic surfactants include fluoroalkylcarboxylic acids each containing 2 to 10 carbon atoms, and metallic salts thereof, disodium perfluorooctanesulfonyl glutamate, sodium 3-[omega-fluoroalkyl (C6-C11)oxy]-1-alkyl (C3-C4) sulfonate, sodium 3-[omega-fluoroalkanoyl (C6-C8)-N-ethylamino]-1-propanesulfonate, fluoroalkyl (C11-C20) carboxylic acids and metallic salts thereof, perfluoroalkyl carboxylic acids (C7-C13) and metallic salts thereof, perfluoroalkyl (C4-C12) sulfonic acids and metallic salts thereof, perfluorooctanesulfonic acid diethanolamide, N-propyl-N-(2-hydroxyethyl) perfluorooctanesulfonamide, perfluoroalkyl (C6-C10) sulfonamide propyl trimethyl ammonium salts, perfluoroalkyl (C6-C10)-N-ethylsulfonyl glycine salts, and monoperfluoroaklyl (C6-C16) ethyl phosphoric esters.

Examples of fluoroalkyl-containing surfactants that are commercially available include SURFLON S-111, S-112, and S-113 (from Asahi Glass Co., Ltd.), FLUORAD FC-93, FC-95, FC-98, and FC-129 (from Sumitomo 3M Limited), UNIDYNE DS-101 and DS-102 (from Daikin Industries, Ltd.), MEGAFAC F-110, F-120, F-113, F-191, F-812, and F-833 (from Dainippon Ink & Chemicals, Incorporated), IFTOP EF-102, EF-103, EF-104, EF-105, EF-112, EF-123A, EF-123B, EF-306A, EF-501, EF-201 and EF-204 (from Tohkem Products Corporation), and FTERGENT F-100 and F-150 (from Neos Co., Ltd.).

Examples of cationic surfactants include amine salts cationic surfactants and quaternary ammonium salts cationic surfactants.

Examples of the amine salts cationic surfactants include alkylamine salts, amino alcohol fatty acid derivatives, polyamine fatty acid derivatives, and imidazoline.

Examples of the quaternary ammonium salts cationic surfactants include alkyltrimethylammonium salts, dialkyldimethylammonium salts, alkyldimethylbenzylammonium salts, pyridinium salts, alkylisoquinolinum salts, and benzethonium chloride.

Other examples of the cationic surfactants include aliphatic primary, secondary and tertiary amine salts each having a fluoroalkyl group; aliphatic quaternary ammonium salts such as perfluoro-alkyl (C6-C10) sulfonamide propyltrimethyl ammonium salts; benzalkonium salts; benzethonium chloride; pyridinium salts; and imidazolinium salts.

Examples of the cationic surfactants that are commercially available include SURFLON S-121 (from Asahi Glass Co., LTD.), FLUORAD FC-135 (from Sumitomo 3M Limited), UNIDYNE DS-202 (from Daikin Industries, LTD.), MEGAFAC F-150 and F-824 (from Dainippon Ink & Chemicals, Incorporated), IFTOP EF-132 (from Tohkem Products Corporation), and FTERGENT F-300 (from Neos Co., Ltd.).

Examples of the nonionic surfactants include fatty acid amide derivatives and polyhydric alcohol derivatives.

Examples of the amphoteric surfactants include alanine, dodecyl di(aminoethyl) glycine, di(octylaminoethyl) glycine, and N-alkyl-N, and N-dimethylammonium betaines.

Examples of the inorganic compound dispersing agents that are slightly soluble in water include tricalcium phosphate, calcium carbonate, titanium oxide, colloidal silica, and hydroxyapatite.

Examples of the polymeric protective colloid include acids, hydroxyl-group-containing (meth) acrylic monomers, vinyl alcohol or ethers thereof, esters of vinyl alcohol and carboxyl-group-containing compound, amide compounds or methylol compounds thereof, chlorides, homopolymers or copolymers such as nitrogen-containing or heterocyclic compounds, polyoxyethylene compounds, and celluloses.

Examples of the acids include acrylic acid, methacrylic acid, alpha-cyanoacrylic acid, alpha-cyanomethacrylic acid, itaconic acid, crotonic acid, fumaric acid, maleic acid, and maleic anhydride.

Examples of the hydroxyl-group-containing (meth)acrylic monomers include beta-hydroxyethyl acrylate, beta-hydroxyethyl methacrylate, beta-hydroxypropyl acrylate, beta-hydroxypropyl methacrylate, gamma-hydroxypropyl acrylate, gamma-hydroxypropyl methacrylate, 3-chloro-2-hydroxypropyl acrylate, 3-chloro-2-hydroxypropyl methacrylate, diethylene glycol monoacrylic ester, diethylene glycol monomethacrylic ester, glycerol monoacrylic ester, glycerol monomethacrylic ester, N-methylolacrylamide, and N-methylolmethacrylamide.

Examples of the vinyl alcohol or ethers thereof include vinyl methyl ether, vinyl ethyl ether, and vinylpropyl ether.

Examples of the esters of the vinyl alcohol and carboxyl-group-containing compound include vinyl acetate, vinyl propionate, and vinyl butyrate.

Examples of the amide compounds or methylol compounds thereof include acrylamide, methacrylamide, diacetone acrylamide acid, and methylol compounds thereof.

Examples of the chlorides include acrylic chloride and methacrylic chloride. Examples of the homopolymers or copolymers such as nitrogen-containing or heterocyclic compounds include vinylpyridine, vinylpyrrolidone, vinylimidazole, and ethyleneimine.

Examples of the polyoxyethylene compounds include polyoxyethylene, polyoxypropylene, polyoxyethylene alkyl amine, polyoxypropylene alkyl amine, polyoxyethylene alkyl amide, polyoxypropylene alkyl amide, polyoxyethylene nonyl phenyl ether, polyoxyethylene lauryl phenyl ether, polyoxyethylene stearyl phenyl ester, and polyoxyethylene nonyl phenyl ester.

Examples of the celluloses include methyl cellulose, hydroxyethyl cellulose, and hydroxypropyl cellulose.

In emulsification and dispersion, a dispersion stabilizer can be used as required.

Examples of the dispersion stabilizer include an alkaline- and acid-dissolvable substance, such as calcium phosphate.

When such a dispersion stabilizer is used, calcium phosphate can be removed from the fine particles by, for example, dissolving calcium phosphate by action of an acid, such as hydrochloric acid, and then cleaning the fine particles, or through decomposition by action of an enzyme.

In emulsification and dispersion, a catalyst for elongation reaction or crosslinking reaction can be used. Examples of the catalyst include dibutyltin laurate and dioctyltin laurate.

From emulsified slurry obtained in emulsification and dispersion, the organic solvent is removed. Examples of a method of removing the organic solvent include (1) a method of gradually increasing the temperature of the entire reactive system to completely evaporate the organic solvent in droplets for removal, and (2) a method of spraying the emulsified dispersoid into a dry atmosphere to completely remove a non-water-based organic solvent in droplets to form toner fine particles and also evaporating the water-based dispersing agent for removal.

Upon removal of the organic solvent, toner particles are formed. Such toner particles can be cleaned and dried, and then be classified, for example, as desired. Such a classifying operation can be performed by, for example, removing fine particle parts by a cyclone, a decanter, a centrifugal separator, or the like, and may be performed after the particles are obtained as powder after drying.

Thus obtained toner particles are mixed with particles of the coloring agent, the releasing agent, the charge control agent, and others, or are further provided with a mechanical impact. With this, it is possible to prevent the particles of the releasing agent and others from being released from the surface of the toner particles.

Examples of a method of applying the mechanical impact include a method of providing an impact onto the mixture by a wing rotating at high speed, and a method of putting the mixture in high-speed airflow and accelerating the mixture to make the particles in contact with one another or make composite particles in contact with an appropriate collision plate. Examples of an apparatus for use in this method include Ang mill (from Hosokawa Micron Corporation), an apparatus obtained by modifying Impact Mill (from Nippon Pneumatic Mfg. Co., Ltd.) to decrease pulverizing air pressure, Hybridization System (from Nara Machinery Co., Ltd.), Kryptron System (from Kawasaki Heavy Industries, Ltd.), and an automatic mortar.

Furthermore, as the toner for use in the image forming apparatus according to the present invention, a toner having its surface coated with an external additive is suitable. By coating the surface of the toner with an external additive, the adhesion force between the toner and the photosensitive member is decreased, and therefore a center defect tends not to occur. A ratio of coating with the external additive is preferably 10% to 90%, and more preferably, 30% to 60%. If the ratio of coating with the the external additive is smaller than 10%, it is difficult to adjust the adhesion force between the toner and the photosensitive member to an appropriate size, thereby causing an increase in center defect. If the ratio of coating with the external additive exceeds 90%, liberation of the external additive tends to occur. In particular, with repeated image formation, a component of the image forming apparatus, such as a photosensitive member, tends to be damaged. Here, the ratio of coating with the external additive can be obtained by measuring a ratio of an area coated with the external additive with respect to the surface area of one toner particle through image analysis on an electron-microscope image of the toner surface.

A suitable external additive is a mixture of fine particles having an average value of primary particle diameters of 50 nanometers to 150 nanometers and ultra-fine particles having a diameter smaller than that of the fine particles. As the particle diameter of the external additive is smaller, the adhesion force is smaller and the agglomeration property is lower. In the case of the particles having an average particle diameter smaller than 50 nanometers, when the toner is stirred for a long time, the external additive is buried in the surface of the toner base material. With the external additive being buried, the adhesion force of the toner is changed, thereby increasing the occurrence of center defect to degrade image quality. Also, as the particles have a large particle diameter, deformation of the toner base at the time of compression can be prevented, thereby reducing an increase in inter-toner adhesion force after compression. However, if the external additive having an average particle diameter of 50 nanometers is used, the particles can be easily released from the toner base to be attached to other members, thereby causing an abnormal image due to filming of the photosensitive member or other factors. Therefore, with the use of an external additive having a small particle diameter to reduce agglomeration property, prevent an increase in attachment after compression of the toner, prevent an increase in adhesion force at the time of stirring the toner for a long time, and stabilize fluidity, it is effective to mix external additive particles having an average particle diameter of 50 nanometers to 150 nanometers for use. Also, it is preferable that the shape of the external additive be substantially spherical. With the shape of the external additive being spherical, burial in the toner base at the time of stirring for a long time tends not to proceed.

Basically, all known materials can be used as the material of the external additive. For example, silica (SiO₂), titanium oxide (TiO₂), and alumina (Al₂O₃) are more preferable.

If inorganic fine particles with hygroscopic properties are used as the external additive, for example, such particles are preferably hydrophobized in view of environmental stability.

A hydrophobizing method is not particularly restricted, and any can be selected as appropriate according to the purpose. One exemplary method is a method of reacting a hydrophobizing agent and the fine powder under high temperature.

The hydrophobizing agent is not particularly restricted, and any can be selected as appropriate according to the purpose. Examples include silane coupling agents and silicone oil.

A method of externally adding the external additive is not particularly restricted, and any can be selected as appropriate according to the purpose. For example, a method of using various mixing devices, such as a V-shaped blender, a Henschel mixer, and Mechanofusion, is suitable.

The volume-average particle diameter of the toner for electrophotography for use in the present embodiment is preferably 1 micrometer to 8 micrometers.

As has been explained above, as the toner particle diameter Dt (micrometers) is smaller, the adhesiveness and agglomeration property are larger. This makes the movement of the toner particles and the control over the toner particles difficult. If the volume-average particle diameter of the toner is smaller than 1 micrometer, an image defect may occur. On the other hand, if the volume-average particle diameter of the toner exceeds 8 micrometers, responding to the demand for high resolution of an electrophotographic image is difficult.

Also, the toner for electrophotography or use in the present embodiment is preferably a mixture of at least two types of toners having different average particle diameters. In particular, a mixture of two types of toners, that is, a toner having a large particle diameter larger than and equal to 4 micrometers and smaller than and equal to 8 micrometers and a toner having a small particle diameter larger than and equal to 1 micrometer and smaller than 4 micrometers, is more preferable. The inventors have confirmed that, in measurement of an inter-toner non-electrostatic adhesion force by Agrobot, as a filling ratio is increased, Ft/Dt [nN/μm] tends to be decreased. A reason for this may be such that, if the filling ratio is high, toner particles support one another at many contact points, and therefore the toner tends not to be deformed with pressure, and the non-electrostatic adhesion force tends not to be increased. By mixing particles having different particle diameters so as to form a layer in which particles having a small particle diameter enter between particles having a large particle diameter, the filling ratio can be increased.

When the electrophotographic toner for use in the present embodiment is used in an image forming apparatus, a voltage applied to the developing unit for development on the image carrier is preferably a voltage obtained by superposing an alternating voltage on a direct voltage. When such a voltage obtained by superposing an alternating voltage on a direct voltage is applied to the developing unit for development, a layer is formed while the toner is vibrated. Therefore, compared with the case in which only a direct voltage is applied, the filling ratio of the developed toner layer can be increased.

Specific examples of toners for electrophotography to which the present invention is applied are explained below. The present invention, however, is not restricted by these examples.

In a reactor equipped with a cooling tube, a stirrer, and a nitrogen supply tube, 810 parts of polyoxylene (2,2)-2,2-bis(4-hydroxyphenol) propane and 300 parts of terephtaric acid, and 2 parts of dibutyltin oxide were placed for reaction at 230° C. under atmospheric pressure for eight hours. Furthermore, the mixture was further reacted under a reduced pressure of 10 millimeters of mercury to 15 millimeters of mercury for five hours, and was then cooled to 160° C. Then, 32 parts of phthalic anhydride was added therein, and the mixture was reacted for two hours.

The reaction mixture was further cooled to 80° C., was reacted with 188 parts of isophorone diisocyanate in ethyl acetate for two hours, thereby obtaining isocyanate-containing prepolymer (1). Next, 267 parts of the isocyanate-containing prepolymer (1) and 14 parts of isophoronediamine were reacted at 50° C. for two hours, thereby obtaining urea-modified polyester (1) having a weight-average molecular weight of 58,000. Similarly, 724 parts of bisphenol A-ethylene oxide adduct 2 moles and 276 parts of terephtaric acid were condensed at 250° C. under atmospheric pressure for five hours, and then were reacted under a reduced pressure of 10 millimeters of mercury to 15 millimeters of mercury for five hours, thereby unmodified polyester (a) having a peak molecular weight of 5000. Then, 200 parts of urea-modified polyester (1) and 800 parts of unmodified polyester (a) were dissolved and mixed in 2000 parts of an ethyl acetate solvent, thereby obtaining an ethyl acetate solution of a toner binder (1). The solution was partly dried under reduced pressure to measure the properties of the toner binder (1). The peak of MW distribution was 5500, Tg was 71° C., and the acid value was 5.5.

In a beaker, 240 parts of the ethyl acetate solution of the toner binder (1) and 4 parts of a phthalocyanine blue pigment were placed. The mixture was stirred using a T.K. HOMO MIXER at 60° C. and at 12,000 RPM so as to be uniformly dissolved and dispersed. In another beaker, 706 parts of ion-exchanged water, 294 parts of a 10% suspension of hydroxyapatite (from Nippon Chemical Industrial Co., Ltd. under the trade name of Supertite 10) and 0.2 parts of sodium dodecylbenzenesulfonate were placed and uniformly dissolved. Next, the mixture was heated to 60° C., the solution of toner materials was introduced into the mixture, while being stirred in the T.K. HOMO MIXER at 12,000 RPM for further 10 minutes. The mixture was then transferred to a flask equipped with a stirring rod and a thermometer, and was then heated to 98° C. to remove the solvent. After filtering, cleaning and drying, the resulting mixture was subjected to air classification, thereby obtaining base particles.

As a charge control agent, 4.0% by weight of zinc chloride of a salicylate derivative with respect to the amount of toner was mixed and stirred in an temperature-increasing atmosphere so that the charge control agent was fixed to the surface of the toner, thereby obtaining toner base particles A having a volume-average particle diameter of 5.8 micrometers and a an average circularity of 1.35. To the toner base particles A, 0.3% by weight of hydrophobic silica A (its average primary particle diameter is 14 nanometers) with respect to the amount of toner, 4.0% by weight of hydrophobic silica B (having round particles with an average primary particle diameter of 120 nanometers) with respect to the amount of toner, and 0.2% by weight of hydrophobic titanium oxide (its average primary particle diameter is 15 nanometers) with respect to the amount of toner were mixed and stirred by a Henschel mixer, thereby producing toner particles of the first example.

In the toner obtained in the first example, by using Agrobot (from Hosokawa Micron Corporation), which is a powder-layer compression and tension strength automatic measuring system, a toner's tension rupture stress St [nN/μm²] after a compressive stress of 0.7×10⁻² [N/m²] and a compressive stress of 1.5×10⁻² [N/m²] are applied is measured. The measured tension rupture stress St [nN/μm²], the previously calculated gap ratio ε, and the previously measured toner particle diameter Dt [μm] are substituted into the Rumpf's equation of Ft=St×Dt²×ε/(1−ε), thereby calculating the inter-toner non-electrostatic adhesion force Ft [nN]. From the obtained Ft [nN], Ft/Dt [nN/μm] is calculated (Ft: inter-toner non-electrostatic adhesion force, Dt: toner volume-average particle diameter).

Application of the compressive stress to the toner and measurement of the toner's tension rupture stress St [nN/μm²], a cell for Agrobot having an internal diameter of 15 millimeters was used. Also, the toner particle diameter Dt [[μm²] was measured by Coulter Multisizer from Coulter Electric.

In the toner obtained in the first example, center defect evaluation with a transfer pressure spring force of 16 newtons was performed by using a color copier ImagioNeo C600 from Ricoh Company Ltd. At this time, only the direct voltage was used as the voltage to be applied to the developing unit.

In this apparatus, one pressure spring is placed at each of both ends of the transfer roller. The transfer pressure spring force is a total value of spring forces at both ends. The degree of center defect represents an evaluation ranking from 1 to 5 (1 represents the best and 5 represent the worst), under evaluation standards similar to those for the degree of center defect explained in FIG. 2, for the state of center defect on an output image by using a test chart with thin lines of 3 dots in a main operating direction by 60 dots in a sub-operating direction being equally arranged. The second rank and lower are within a range in which there is no problem as an image.

Upon calculation of Ft/Dt [nN/μm] of the toner according to the first example, 2.50 [nN/μm] was obtained when the compressive stress of 0.7×10⁻² [N/m²] was applied, whilst 2.71 [nN/μm] was obtained when the compressive stress of 1.533 10⁻² [N/m²] was applied. Also, the degree of center defect at the time of image formation with the transfer pressure spring force of 16 newtons was 1.

After toner compositions, such as resin and a coloring agent, were mixed and stirred, the resultant substance was molten and kneaded. Then, the molten and kneaded component material were ground and classified to obtain indefinitely-shaped toner base particles B. The volume-average particle diameter of the toner base particles B was 7.6 micrometers, and the average value of circularity was 1.52. The obtained toner base particles B were heated to a temperature higher than a softening point of binding resin in a heat airflow, thereby performing a process of making the particles spherical. Furthermore, after the process of making the particles spherical, the particles were classified to produce spherical toner base particles C. The volume-average particle diameter of the obtained toner base particles C was 7.6 micrometers, and the average value of circularity was 1.20.

To the toner base particles C, 0.6% by weight of hydrophobized silica A (its average primary particle diameter was 14 nanometers) with respect to the amount of toner and 0.7% by weight of hydrophobized titanium oxide A (its average primary particle diameter was 15 nanometers) with respect to the amount of toner were mixed. The resultant mixture was then stirred and mixed by a Henschel mixer to produce toner particles according to a second example.

As for thus obtained toner according to the second example, Ft/Dt [nN/μm] was calculated for center defect evaluation in a manner similar to that in the first example.

Upon calculation of Ft/Dt [nN/μm] of the toner according to the second example, 1.82 [nN/μm] was obtained when the compressive stress of 0.7×10⁻² [N/m²] was applied, whilst 2.52 [nN/μm] was obtained when the compressive stress of 1.5×10⁻² [N/m²] was applied. Also, the degree of center defect at the time of image formation with the transfer pressure spring force of 16 newtons was 1.

To the toner base particles A produced in a manner similar to that according to the first example, 0.3% by weight of hydrophobized silica A and 0.2% by weight of hydrophobized titanium oxide A were mixed. The resultant mixture was then stirred and mixed by a Henschel mixer to produce toner particles according to a first comparison example.

As for thus obtained toner according to the first comparison example, Ft/Dt [nN/μm] was calculated for center defect evaluation in a manner similar to that in the first example.

Upon calculation of Ft/Dt [nN/μm] of the toner according to the first comparison example, 3.20 [nN/μm] was obtained when the compressive stress of 0.7×10⁻² [N/m²] was applied, whilst 4.51 [nN/μm] was obtained when the compressive stress of 1.5×10⁻² [N/m²] was applied. Also, the degree of center defect at the time of image formation with the transfer pressure spring force of 16 newtons was 4.

In the first comparison example, the toner base particles A similar to those in the first example were used. However, the value of Ft/Dt [nN/μm] was significantly increased possibly because no hydrophobized silica B (its average primary particle diameter was 120 nanometers) was added. As a result, Ft/Dt [nN/μm] exceeded 3.0, thereby deteriorating the degree of center defect.

To the toner base particles B produced in a manner similar to that according to the second example having a volume-average particle diameter of 7.6 micrometers and an average value of circularity of 1.52, 0.6% by weight of hydrophobized silica A and 0.7% by weight of hydrophobized titanium oxide A were mixed. The resultant mixture was then stirred and mixed by a Henschel mixer to produce toner particles according to a second comparison example.

As for thus obtained toner according to the second comparison example, Ft/Dt [nN/μm] was calculated for center defect evaluation in a manner similar to that in the first example.

Upon calculation of Ft/Dt [nN/μm] of the toner according to the second comparison example, 4.25 [nN/μm] was obtained when the compressive stress of 0.7×10⁻² [N/m²] was applied, whilst 5.84 [nN/μm] was obtained when the compressive stress of 1.5×10⁻² [N/m²] was applied. Also, the degree of center defect at the time of image formation with the transfer pressure spring force of 16 newtons was 5.

In the second comparison example, the toner base particles B having a composition identical to that of the second example were used. The value of Ft/Dt [nN/μm] was significantly increased possibly because the circularity was extremely large compared with the toner base particles C subjected to the process of making the particles spherical. As a result, Ft/Dt [nN/μm] exceeded 3.0, thereby deteriorating the degree of center defect.

In the second comparison example and the second example, the volume-average particle diameter and the external additive are the same, and only the average value of circularities is different. The degree of center defect in the second example is 1, meaning a good state, whilst the degree of center defect in the second comparison example is 5, representing an image defect. From this, it can be thought that, as the shape of the toner is closer to a sphere, the amount of increase in the toner's inter-toner non-electrostatic adhesion force after a compressive stress is applied is decreased.

To the toner base particles B produced in a manner similar to that according to the second example having a volume-average particle diameter of 7.6 micrometers and an average value of circularity of 1.52, 0.6% by weight of hydrophobized silica A, 1.0% by weight of hydrophobized silica B, and 0.7% by weight of hydrophobized titanium oxide A were mixed. The resultant mixture was then stirred and mixed by a Henschel mixer to produce toner particles according to a third comparison example.

As for thus obtained toner according to the third comparison example, Ft/Dt [nN/μm] was calculated for center defect evaluation in a manner similar to that in the first example.

Upon calculation of Ft/Dt [nN/μm] of the toner according to the third comparison example, 2.90 [nN/μm] was obtained when the compressive stress of 0.7×10⁻² [N/m²] was applied, whilst 3.25 [nN/μm] was obtained when the compressive stress of 1.5×10⁻² N/m²] was applied. Also, the degree of center defect at the time of image formation with the transfer pressure spring force of 16 new-tons was 4.

In the third comparison example, the toner base particles B similar to those in the second comparison example were used. Since silica B (its average primary particle diameter was 120 nanometers) was added, the value of Ft/Dt [nN/μm] was slightly improved. The degree of center defect was also improved. However, the value of Ft/Dt [nN/μm] when the compressive stress of 1.5×10⁻² [N/m²] was applied was significantly increased possibly because the circularity of the toner base particles B was extremely large. As a result, Ft/Dt [nN/μm] exceeded 3.0, thereby deteriorating the degree of center defect.

The toner having a circularity of 1.20 for use in the second example and the toner having a circularity of 1.52 for use in the second comparison example were mixed at a weight ratio of 1:1 to produce a toner having a volume-average particle diameter of 7.6 micrometers and an average value of circularities of 1.385.

As for thus obtained toner according to the third example, Ft/Dt [nN/μm] was calculated for center defect evaluation in a manner similar to that in the first example.

Upon calculation of Ft/Dt [nN/μm] of the toner according to the third example, 1.85 [nN/μm] was obtained when the compressive stress of 0.7×10⁻² [N/m²] was applied, whilst 2.25 [nN/μm] was obtained when the compressive stress of 1.5×10⁻² [N/m²] was applied. Also, the degree of center defect at the time of image formation with the transfer pressure spring force of 16 newtons was 1.

As such, by mixing toners having different circularities, the adhesion force after compression was further decreased compared with the toner having an approximately similar circularity, and a center defect almost did not occur.

As with the second example, after toner compositions, such as resin and a coloring agent, were mixed and stirred, the resultant substance was molten and kneaded. Then, the molten and kneaded component material were ground and classified to obtain indefinitely-shaped toner base particles D. The volume-average particle diameter of the toner base particles D was 3.6 micrometers, and the average value of circularity was 1.53. To the toner base particles D, 1.3% by weight of hydrophobized silica A and 1.5% by weight of hydrophobized titanium oxide A were mixed. The resultant mixture was then stirred and mixed by a Henschel mixer to produce a toner.

Then, this toner having the volume-average particle diameter of 3.6 micrometers and a toner produced in the second embodiment by mixing 0.6% by weight of hydrophobized silica A having a volume-average particle diameter of 7.6 micrometers and an average value of circularity of 1.52 and 0.7% by weight of hydrophobized titanium oxide A were mixed at a weight ratio of 1:1 to produce a toner according to a fourth example.

As for thus obtained toner according to the fourth example, Ft/Dt [nN/μm] was calculated for center defect evaluation in a manner similar to that in the first example.

Upon calculation of Ft/Dt [nN/μm] of the toner according to the fourth example, 2.32 [nN/μm] was obtained when the compressive stress of 0.7×10⁻² [N/m²] was applied, whilst 2.92 [nN/μm] was obtained when the compressive stress of 1.5×10⁻² [N/m²] was applied. Also, the degree of center defect at the time of image formation with the transfer pressure spring force of 16 newtons was 2.

Furthermore, a voltage having a direct voltage and an alternating voltage superposed was applied to the developing unit, and the degree of center defect at the time of image formation with the transfer pressure spring force of 16 newtons was 1.

The values of Ft/Dt [nN/μm] after the compressive stress was applied and the evaluations on the degrees of center defect at the time of image formation with the transfer pressure spring force of 16 newtons in the first, second, third examples and the first and second comparison examples are depicted in Table 1.

TABLE 1

| EMBODIMENTS | Ft/Dt [nN/μm] | | DEGREE |
|---|---|---|---|
| AND COMPARISON | | 1.5 × 10⁻² | OF CENTER |
| EXAMPLES | 0.7 × 10⁻² [N/m²] | [N/m²] | DEFECT |
| FIRST | 2.50 | 2.72 | 1 |
| EMBODIMENT | | | |
| SECOND | 1.82 | 2.52 | 1 |
| EMBODIMENT | | | |
| FIRST | 3.20 | 4.51 | 4 |
| COMPARISON | | | |
| EXAMPLE | | | |
| SECOND | 4.25 | 5.84 | 5 |
| COMPARISON | | | |
| EXAMPLE | | | |
| THIRD | 2.90 | 3.25 | 4 |
| COMPARISON | | | |
| EXAMPLE | | | |
| THIRD | 1.85 | 2.25 | 1 |
| EMBODIMENT | | | |
| FOURTH | 2.32 | 2.92 | 2 |
| EMBODIMENT | | | |

| | |
|---|---|
| ALTERNATING VOLTAGE IS APPLIED TO | 1 |
| FOURTH EMBODIMENT | |

As described in Table 1, in the first to third embodiments, Ft/Dt [nN/μm] calculated after the compressive stress of 0.7×10⁻² [N/m²] and the compressive stress of 1.5×10⁻² [N/m²] were applied is equal to or smaller than 3.0 [nN/μm]. Also, the degree of center defect with the transfer pressure spring force of 16 newtons is low. Therefore, an excellent image can be obtained also in the image forming apparatus under normal use.

As described above, according to the present embodiments, image formation is performed by using a toner for electrophotography satisfying a relation of Ft/Dt≦3.0 [nN/μm], where Ft (nanonewtons) is an inter-toner non-electrostatic adhesion force after a compressive stress within 0.7×10⁻² [N/m²] to 1.5×10⁻² [N/m²] is applied, the force being calculated from a toner's tension rupture stress measured after the compressive stress is applied, and Dt (micrometers) is a toner particle diameter. With this, even when a pressure concentrates on the toner image at the time of transfer from the image carrier to the intermediate transfer medium, an increase in the inter-toner non-electrostatic adhesion force with respect to the toner particle diameter of the toner for forming the toner image can be suppressed. With this, excellent image formation can be performed with the occurrence of a center defect phenomenon being suppressed.

A toner having an average value of circularities is 1.0 to 1.4 is used. Since a spherical toner's non-electrostatic adhesion force after a compressive stress is applied tends not to be increased, a center defect can be suppressed.

Furthermore, a toner obtained by mixing a toner having an average value of circularities larger than 1.4 with a toner having a circularity smaller than 1.4 in a process preceding at least to a transfer process is used. With this, a center defect can be suppressed with cleaning ability being increased.

Moreover, toners having different shapes are mixed in advance at the time of shipping at a predetermined ratio, and a toner container containing such toners is attached to an image forming apparatus for use. This attaching operation is similar to a normal toner replacing operation, and therefore this operation does not impose a burden on the user.

Furthermore, toners having different shapes are mixed and stirred with a carrier in the developing unit. With this, a mixing ratio of the toners having different shapes can be changed according to the situation. With this, the average value of circularities of the toner for use can be adjusted.

Moreover, a toner is used in which the toner particles are formed of toner base particles and an external additive and the external additive is a mixture of fine particles having a volume-average particle diameter of 50 nanometers to 150 nanometers and ultra-fine particles having a diameter smaller than that of the fine particles. With the external additive of ultra-fine particles, the adhesion force between toners can be decreased. With the fine particles having a volume-average particle diameter of 50 nanometers to 150 nanometers, the external additive can be prevented from being buried in the toner base particles, and the adhesion force of the toner can be prevented from being changed. Therefore, a center defect can be suppressed for a long time.

Furthermore, the volume-average particle diameter of the toner is within a range of 1 micrometer to 8 micrometers. With this, the demand for high resolution of an electrophotographic image can be satisfied with the occurrence of an image defect being suppressed.

Moreover, toners having different average particle diameters are mixed and used to increase a filling ratio of the toner layer. With this, the non-electrostatic adhesion force of the toner after a compression stress is applied tends not to be increased, and therefore a center defect can be suppressed.

Furthermore, the toner according to the present embodiments is used as a toner for electrophotography for use in the printer 100, which is an image forming apparatus. With this, a high-quality image without a center defect at the time of transfer can be provided.

Moreover, in the printer 100, which is an image forming apparatus using the toner according to the present embodiments, a voltage applied to the developing unit is a voltage having an alternating voltage and a direct voltage applied. With this, a center defect can be further suppressed.

In the toner for electrophotography according to aspects of the present invention, as a result of the experiments performed by the inventors, which have been explained above by using FIGS. 2 and 3, it has been found that, with a toner whose Ft/Dt obtained by dividing the inter-toner non-electrostatic adhesion force Ft after the compressive stress within 0.7×10⁻² [N/m²] to 1.5×10⁻² [N/m²] is applied by the toner particle diameter Dt is smaller than or equal to 3.0 [nN/μm], the occurrence of a center defect can be suppressed even if image formation is performed under a condition where a pressure tends to concentrate on the toner image at the time of transfer from the image carrier to the intermediate transfer member.

As describe above, according to an embodiment of the present invention, an effect can be achieved such that the occurrence of a center defect phenomenon at the time of transfer from the image carrier to the intermediate transfer member can be suppressed, thereby making it possible to perform excellent image formation.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A toner for electrophotography used in an image formation in which a toner image is formed by supplying a toner to a latent image formed on an image carrier, and the toner image is transferred onto a recording medium by using a transfer unit including an intermediate transfer member that on which the toner image is transferred from the image carrier, the toner for electrophotography satisfying
Ft/Dt≦3.0 [nN/μm]
where Ft is an inter-toner non-electrostatic adhesion force after a compressive stress within 0.7×10⁻² [N/m²] to 1.5×10⁻² [N/m²] is applied, and Dt is a toner particle diameter, wherein
the inter-toner non-electrostatic adhesion force is obtained by filling a two-dividable cell for an Agrobot manufactured by Hosokawa Micron Corporation having a diameter of 15 millimeters, measuring a tension rupture stress required for dividing the cell after a compressive stress is applied, and substituting the tension rupture stress into Rumpf's equation, Ft=St×Dt²×ε/(1−ε), where St [nN/μm] is the tension rupture stress measured by applying a predetermined compressive stress to the toner, and ε is a toner-layer gap ratio.

2. The toner for electrophotography according to claim 1, wherein
an average value of circularity of the toner is equal to or larger than 1.0 and equal to or smaller than 1.4.

3. The toner for electrophotography according to claim 1, comprising:
a toner manufactured so that an average value of the circularity is larger than a predetermined value; and
a toner manufactured so that an average value of the circularity is smaller than the predetermined value.

4. The toner for electrophotography according to claim 3, wherein
the predetermined value is 1.4.

5. The toner for electrophotography according to claim 1, wherein
a toner particle is formed of a toner base particle and an external additive, and
the external additive is a mixture of a fine particle having a volume-average particle diameter equal to or larger than 50 nanometers and equal to or smaller than 150 nanometers and an ultra-fine particle having a diameter smaller than the diameter of the fine particle.

6. The toner for electrophotography according to claim 5, wherein
the external additive includes at least one of silicon oxide, titanium oxide, and aluminum oxide.

7. The toner for electrophotography according to claim 1, wherein
a particle diameter is adjusted to be 1 micrometer to 8 micrometers.

8. The toner for electrophotography according to claim 1, wherein
at least two types of toners having different average particle diameters are mixed.

9. The toner for electrophotography according to claim 8, wherein
two types of toner particles having different average particle diameters are mixed, including one toner particle and other toner particle, and
the one toner particle is adjusted to have a particle diameter equal to or larger than 4 micrometers and equal to or smaller than 8 micrometers, and the other toner particle is adjusted to have a particle diameter equal to or larger than 1 micrometer and smaller than 4 micrometers.

10. An image forming apparatus comprising:
an image carrier on which a latent image is formed;
a developing unit that forms a toner image by supplying a toner to the latent image formed on the image carrier; and
a transfer unit including an intermediate transfer member unit on which of the toner image is transferred from the image carrier, wherein
the toner is a toner for electrophotography satisfying
Ft/Dt≦3.0 [nN/μm]
where Ft is an inter-toner non-electrostatic adhesion force after a compressive stress within 0.7×10⁻² N/m² to 1.5×10⁻² N/m² is applied, and Dt is a toner particle diameter, and
the inter-toner non-electrostatic adhesion force is obtained by filling a two-dividable cell for an Agrobot manufactured by Hosokawa Micron Corporation having a diameter of 15 millimeters, measuring a tension rupture stress required for dividing the cell after a compressive stress is applied, and substituting the tension rupture stress into Rumpf's equation, Ft=St×Dt²×ε/(1−ε), where St (nN/μm) is the tension rupture stress measured by applying a predetermined compressive stress to the toner, and ε is a toner-layer gap ratio.

11. The image forming apparatus according to claim 10, wherein
a direct voltage and an alternating voltage superposed on the direct voltage are applied to the developing unit.

12. A method of manufacturing a toner for electrophotography that is used in an image formation in which a toner image is formed by supplying a toner to a latent image formed on an image carrier, and the toner image is transferred onto a recording medium by using a transfer unit including an intermediate transfer member that on which the toner image is transferred from the image carrier, wherein
the toner for electrophotography satisfies
Ft/Dt≦3.0 [nN/μm]
where Ft is an inter-toner non-electrostatic adhesion force after a compressive stress within 0.7×10⁻² [N/m²] to 1.5×10⁻² [N/m²] is applied, and Dt is a toner particle diameter,
the inter-toner non-electrostatic adhesion force is obtained by filling a two-dividable cell for an Agrobot manufactured by Hosokawa Micron Corporation having a diameter of 15 millimeters, measuring a tension rupture stress required for dividing the cell after a compressive stress is applied, and substituting the tension rupture stress into Rumpf's equation, Ft=St×Dt²×ε/(1−ε), where St [nN/μm] is the tension rupture stress measured by applying a predetermined compressive stress to the toner, and ε is a toner-layer gap ratio,
the toner for electrophotography comprises
a first toner manufactured so that an average value of the circularity is larger than a predetermined value, and
a second toner manufactured so that an average value of the circularity is smaller than the predetermined value, and
the toner for electrophotography is manufactured by mixing the first toner and the second toner in a container at a time of shipping.

13. The method according to claim 12, wherein
the toner for electrophotography is manufactured by mixing the first toner and the second toner with a carrier in an agitating container.
